(19) United States
(12) Patent Application Publication
(10) Pub. No.: US 2026/0095673 A1
(43) Pub. Date: Apr. 2, 2026

(54) FLASH AND FLASH ILLUMINATION METHOD

(71) Applicant: GUANGZHOU LUXVISIONS INNOVATION TECHNOLOGY LIMITED, Guangzhou City (CN)

(72) Inventors: Wei-Han Wu, Guangzhou City (CN); Lee Lin Tsai, Guangzhou City (CN); Jui Kuang Tsai, Guangzhou City (CN); Chao Yi Chen, Guangzhou City (CN)

(73) Assignee: GUANGZHOU LUXVISIONS INNOVATION TECHNOLOGY LIMITED, Guangzhou City (CN)

(21) Appl. No.: 19/221,518

(22) Filed: May 29, 2025

Related U.S. Application Data
(60) Provisional application No. 63/699,810, filed on Sep. 27, 2024.

(30) Foreign Application Priority Data
Jan. 10, 2025 (CN) 202510044117.8

(51) Int. Cl. H04N 23/74; G03B 15/05; H04N 23/71

(52) U.S. Cl. CPC H04N 23/74; G03B 15/05; H04N 23/71

(57) ABSTRACT

The disclosure provides a flash, including: a light source module, including an LED array and used to emit light; an image capture device; a light source controller, electrically connected to the light source module and used to control a light emitting state of the light source module; a main controller, electrically connected to the image capture device and the light source controller. The main controller is configured to: enable the image capture device to capture a first image; analyze the first image to determine an LED irradiation region; determine multiple first LEDs that need to be turned on in the LED array according to the LED irradiation region; and send a light source control signal to the light source controller, so that the light source controller sends a control current, and turns on the first LEDs.

### CROSS-REFERENCE TO RELATED APPLICATION

This application claims the priority benefit of U.S. provisional application Ser. No. 63/699,810, filed on Sep. 27, 2024 and China application serial no. 202510044117.8, filed on Jan. 10, 2025. The entirety of each of the above-mentioned patent applications is hereby incorporated by reference herein and made a part of this specification.

### BACKGROUND

### Technical Field

The disclosure relates to a flash and a flash illumination method.

### Description of Related Art

When using a portable device (for example, a mobile phone) to capture images, a flash may be used to increase ambient brightness. Conventional light emitting diode (LED) flashes are mostly arranged in concentric circles, which may cover a large range of a capture region, but requires a larger number of LEDs, and it is difficult to fill light for specific detail positions during capture.

### SUMMARY

Some embodiments of the disclosure provide a flash, including: a light source module, including an LED array and used to emit light; an image capture device; a light source controller, electrically connected to the light source module and used to control a light emitting state of the light source module; a main controller, electrically connected to the image capture device and the light source controller. The main controller is configured to: enable the image capture device to capture a first image; analyze the first image to determine an LED irradiation region; determine multiple first LEDs that need to be turned on in the LED array according to the LED irradiation region; and send a light source control signal to the light source controller, so that the light source controller sends a control current, and turns on the first LEDs.

In addition, other embodiments of the disclosure provide a flash illumination method, including: controlling an image capture device to capture a first image by a main controller; analyzing the first image to determine an LED irradiation region in an LED array of a light source module by the main controller; determining multiple first LEDs that need to be turned on in the LED array according to the LED irradiation region by the main controller; sending a light source control signal to the light source controller by the main controller, so that the light source controller sends a control current, turns on the first LEDs, and captures a second image; analyzing the second image and confirming whether the second image complies with a required standard by the main controller; when the second image complies with the required standard, storing the second image; when the second image does not comply with the required standard, sending the light source control signal to the light source controller again by the main controller, so that the light source controller sends the control current, turns on the first LEDs, and captures a third image.

Based on the above, in the flash and the flash illumination method provided by the disclosure, the capture effect of the LED flash is optimized through the elliptically arranged LED flash in conjunction with the micro motor and algorithm operation, which may cover a large range of the capture region, and only the required LEDs are illuminated. Therefore, the system power consumption may be reduced, and light may be filled for specific detail positions during capture to be suitable for flash capture under various ambient brightness.

### BRIEF DESCRIPTION OF THE DRAWINGS

FIG. 1 is a schematic diagram of a flash in a portable device according to an embodiment of the disclosure.

FIG. 2 is a schematic diagram of a flash according to an embodiment of the disclosure.

FIG. 3 is a schematic diagram of a light source module according to an embodiment of the disclosure.

FIG. 4A is a schematic diagram of an LED array according to an embodiment of the disclosure.

FIG. 4B is a schematic diagram of another LED array according to an embodiment of the disclosure.

FIG. 5A is a schematic diagram of a first image according to an embodiment of the disclosure.

FIG. 5B is a schematic diagram of a first image and an LED array according to an embodiment of the disclosure.

FIG. 6A is a schematic diagram of a first image according to an embodiment of the disclosure.

FIG. 6B is a schematic diagram of a first image and an LED array according to an embodiment of the disclosure.

FIG. 7A is a schematic diagram of a first image according to an embodiment of the disclosure.

FIG. 7B is a schematic diagram of a first image and an LED array according to an embodiment of the disclosure.

FIG. 8A is a schematic diagram of a first image and an LED array according to an embodiment of the disclosure.

FIG. 8B is a schematic diagram of a first image and an LED array according to an embodiment of the disclosure.

FIG. 9 is a flowchart of a flash illumination method according to an embodiment of the disclosure.

### DESCRIPTION OF THE EMBODIMENTS

The following lists embodiments and describes the embodiments in detail with reference to the drawings, but the embodiments provided are not intended to limit the scope of the disclosure. In addition, the sizes of components in the drawings are drawn for the convenience of explanation and do not represent the actual size ratios of the components. Furthermore, although terms such as “first” and “second” are used herein to describe different components and/or film layers, the components and/or the film layers should not be limited to the terms. Rather, the terms are only used to distinguish one component or film layer from another component or film layer. Therefore, a first component or film layer discussed below may be referred to as a second component or film layer without departing from the teachings of the embodiments. For easier understanding, similar components will be described below with the same numerals.

In describing the embodiments of the disclosure, different examples may use repeated reference numerals and/or terms. The repeated numerals or terms are for the purpose of simplicity and clarity, and are not used to limit the relationship between various embodiments and/or described appearance structures. Furthermore, if the following invention content of the specification describes that a first feature is formed on or above a second feature, it means that the same includes an embodiment in which the first feature and the second feature are in direct contact, and also includes an embodiment in which an additional feature is formed between the first feature and the second feature, so that the first feature and the second feature may not be in direct contact. For easier understanding, similar components will be described below with the same numerals.

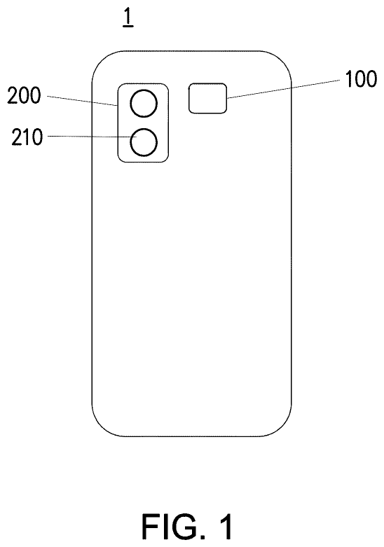

FIG. 1 is a schematic diagram of a flash in a portable device according to an embodiment of the disclosure.

Please reference FIG. 1. FIG. 1 is an appearance of a portable electronic device 1. In some embodiments, the portable electronic device 1 may be a mobile phone, a tablet computer, or other devices with similar functions. The appearance of the portable electronic device 1 exposes some components of the flash, including a light source module 100 and an image capture device 200, wherein the image capture device 200 includes at least one lens 210 used to capture images in conjunction with the light source module 100.

The specific structure of the flash is explained in the following.

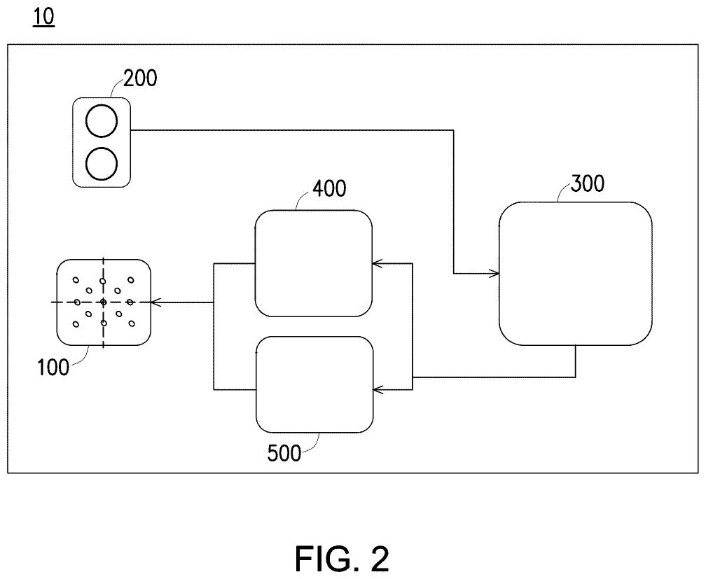

FIG. 2 is a schematic diagram of a flash according to an embodiment of the disclosure.

Please reference FIG. 2. A flash 10 includes the light source module 100, the image capture device 200, a main controller 300, and a light source controller 400.

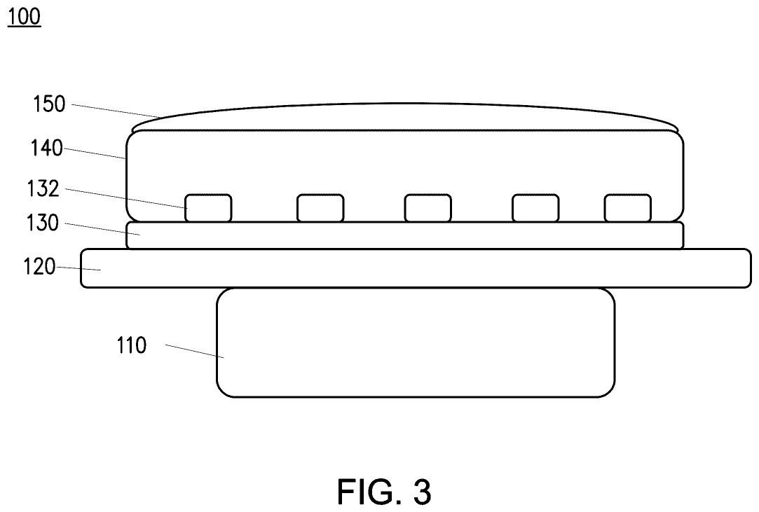

The light source module 100 includes a light emitting diode (LED) array (not shown in FIG. 2) used to emit light. The specific structure of the light source module 100 will be explained in FIG. 3.

The image capture device 200 is used to capture images. In some embodiments, as shown in FIG. 1, the image capture device 200 includes at least one lens 210, but the type, the number, the size, and the position of the lens 210 may be adjusted according to actual requirements, and the disclosure is not limited thereto.

The light source controller 400 is electrically connected to the light source module 100 and is used to control a light emitting state of the light source module 100. Specifically, the light source controller 400 is electrically connected to each LED in the LED array 132 of the light source module 100 to individually control the turning on and off of each LED. In some embodiments, the light source controller 400 may be a circuit, an electronic component, or a processor controlled by software, and the disclosure is not limited thereto.

The main controller 300 is electrically connected to the image capture device 200 and the light source controller 400. The main controller 300 is used to analyze the image captured by the image capture device 200 and determine an irradiation region corresponding to the LED array 132 in the light source module 100 and current through the LED array 132. Specifically, the main controller 300 is configured to execute the following functions of: enabling the image capture device 200 to capture a first image 600; analyzing the first image 600 to determine an LED irradiation region 610; determining multiple first LEDs in the LED array 132 that need to be turned on according to the LED irradiation region 610; sending a light source control signal to the light source controller 400, so that the light source controller 400 sends a control current, and turns on the first LEDs.

The functions and the effects of the main controller 300 will be explained in the following.

In some embodiments, the main controller 300 may be a central processing unit (CPU), a microprocessor control unit (MCU), a field programmable gate array (FPGA), or other such processing circuits or control circuits with computational functions, and the disclosure is not limited thereto. The main controller 300 may be integrated with the light source controller 400 into a control module or the main controller 300 may belong to a processing unit of an electronic device integrated with the light source controller 400. Furthermore, the main controller 300 may also include a memory used to store images, programs, or algorithms mentioned in various embodiments of the disclosure for the main controller 300 to access and execute.

FIG. 3 is a schematic diagram of a light source module according to an embodiment of the disclosure.

Please reference FIG. 3. The light source module 100 includes a substrate 130, the LED array 132, a housing 140, and a lens 150.

The LED array 132 is disposed on the substrate 130. In some embodiments, the substrate 130 may be a printed circuit board (PCB), a flexible circuit board (FPC), or a substrate of other suitable materials, and the disclosure is not limited thereto.

The LED array 132 includes multiple LEDs arranged on the substrate 130 in a specific manner. In some embodiments, the LED array includes one or more combinations of monochromic LEDs or white LEDs, wherein the monochromic LEDs include red LEDs, green LEDs, blue LEDs, and the disclosure is not limited thereto.

Each LED in the LED array 132 may be independently turned on or off, so the light source brightness and the illumination manner may be optimized according to the shape of a captured object.

The housing 140 is disposed on the substrate 130 and surrounds the LED array 132, and is used to form a chamber to protect the LED array 132. In some embodiments, the material of the housing 140 may be plastic to reduce the weight of the housing 140 and have sufficient strength to protect the LED array 132.

The lens 150 is disposed on the housing 140 and covers the LED array 132, and is used to focus and shape a beam emitted by the LED array 132 to comply with illumination requirements. In some embodiments, the lens 150 may be a plastic lens or a Fresnel lens to reduce the lens weight and reduce the lens thickness, so as to reduce the volume of the light source module 100.

As shown in FIG. 3, the light source module 100 also includes a rotation platform 120 and a rotation motor 110. In addition, as shown in FIG. 2, the flash 10 further includes a rotation motor controller 500.

As shown in FIG. 3, the rotation platform 120 is disposed at a bottom portion of the substrate 130 and is used to support the substrate 130. The rotation platform 120 may rotate the substrate 130 in a clockwise direction or a counterclockwise direction to change an illumination direction of the LED array 132.

The rotation motor 110 is disposed at a bottom portion of the rotation platform 120 and drives the rotation platform 120 to rotate through the rotation motor 110. In some embodiments, the rotation motor 110 may be a stepping motor or a micro-drive motor to precisely control a rotation angle of the rotation platform 120.

As shown in FIG. 2, the rotation motor controller 500 is electrically connected to the rotation motor 110 and the main controller 300, and is used to drive the rotation motor 110 to control the direction of the LED array 132. Specifically, the rotation motor controller 500 is used to receive a rotation motor control signal sent by the main controller 300, so that the rotation motor 110 rotates and drives the rotation platform 120, such that the light source module 100 rotates by the rotation angle.

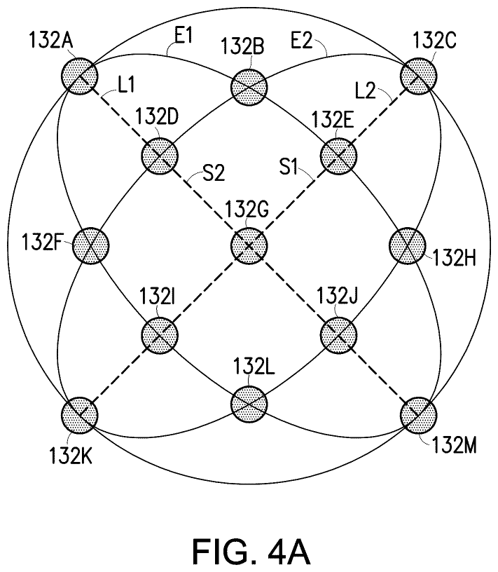

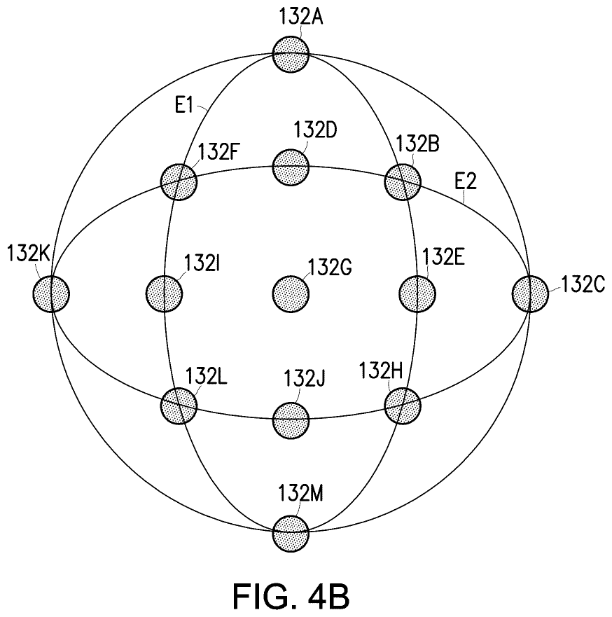

FIG. 4A is a top view of an LED array according to an embodiment of the disclosure. FIG. 4B is a top view of another LED array according to an embodiment of the disclosure.

Please first refer to FIG. 4A. As shown in FIG. 4A, the LED array 132 is disposed on the substrate 130 and includes multiple LEDs, that is, an LED 132A to an LED 132M.

The LED array 132 includes multiple LEDs, that is, the LED 132A to the LED 132M. In other embodiments, there may be other numbers of LEDs, and the disclosure is not limited thereto. The LEDs, that is, the LED 132A to the LED 132M, are distributed within a range formed by a first ellipse E1 and a second ellipse E2.

As shown in FIG. 4A, the LED 132A, the LED 132B, the LED 132D, the LED 132F, the LED 132E, the LED 132G, the LED 132I, the LED 132H, the LED 132J, the LED 132L, and the LED 132M are all located within the first ellipse E1. The LED 132C, the LED 132B, the LED 132E, the LED 132H, the LED 132D, the LED 132G, the LED 132J, the LED 132F, the LED 132I, the LED 132L, and the LED 132K are all located within the second ellipse E2.

A long axis L1 of the first ellipse E1 passes through the LED 132A, the LED 132D, the LED 132G, the LED 132J, and the LED 132M.

A short axis S1 of the first ellipse E1 passes through the LED 132E, the LED 132G, and the LED 132I.

A long axis L2 of the second ellipse E2 passes through the LED 132C, the LED 132E, the LED 132G, the LED 132I, and the LED 132K.

A short axis S2 of the second ellipse E2 passes through the LED 132D, the LED 132G, and the LED 132J.

Therefore, the short axis S2 of the second ellipse E2 is a part of the long axis L1 of the first ellipse E1, and the short axis S1 of the first ellipse E1 is a part of the long axis L2 of the second ellipse E2.

As shown in FIG. 4A, the long axis L1 of the first ellipse E1 passes through the midpoint of the long axis L2 of the second ellipse E2, that is, the LED 132G, and is perpendicular to the long axis L2 of the second ellipse E2, and the size of the first ellipse E1 is the same as the size of the second ellipse E2.

Therefore, the first ellipse E1 and the second ellipse E2 are two ellipses of the same size, the same shape, and with the long axes L1 and L2 perpendicular to each other.

Through arranging the LEDs of the LED array 132 in the form of two orthogonal ellipses, the arrangement of the LEDs may have directionality, and the total number of LEDs may be reduced.

As shown in FIG. 4A, the LEDs within the first ellipse E1 are arranged in a first distribution, the LEDs within the second ellipse E2 are arranged in a second distribution, and the first distribution and the second distribution have the same shape.

Specifically, in the first distribution, the LEDs within the first ellipse E1 are mirror-symmetrical along the long axis L1 of the first ellipse E1 or mirror-symmetrical along the short axis S1 of the first ellipse E1. For example, the LED 132B, the LED 132E, and the LED 132H are mirror-symmetrical with the LED 132F, the LED 132I, and the LED 132L along the long axis L1 of the first ellipse E1. In addition, the LED 132B, the LED 132A, the LED 132D, and the LED 132F are mirror-symmetrical with the LED 132H, the LED 132M, the LED 132J, and the LED 132L along the short axis S1 of the first ellipse E1.

On the other hand, since the first ellipse E1 and the second ellipse E2 are of the same size and the same shape, in the second distribution, the LEDs within the second ellipse E2 are mirror-symmetrical along the long axis L2 of the second ellipse E2 or mirror-symmetrical along the short axis S2 of the second ellipse E2. For example, the LED 132B, the LED 132D, and the LED 132F are mirror-symmetrical with the LED 132H, the LED 132J, and the LED 132L along the long axis L2 of the second ellipse E2. In addition, the LED 132F, the LED 132K, the LED 132I, and the LED 132L are mirror-symmetrical with the LED 132B, the LED 132C, the LED 132E, and the LED 132H along the short axis S2 of the second ellipse E2.

Please reference FIG. 4B. Since the LED array 132 is located on the substrate 130, and the substrate 130 is located on the rotation platform 120, through the rotation of the rotation platform 120, the rotation of the substrate 130 may be driven to change the position of the LED array 132. For example, FIG. 4B shows a result of the LED array 132 in FIG. 4A rotated by 45 degrees in the clockwise direction. In other embodiments, the LED array 132 may rotate any angle in the clockwise direction or the counterclockwise direction to optimize the illumination effect.

According to the image analysis of the main controller 300, the main controller 300 determines the LED irradiation region, and enhance the lighting for the LED irradiation region for capture. The following exemplifies a flash illumination method.

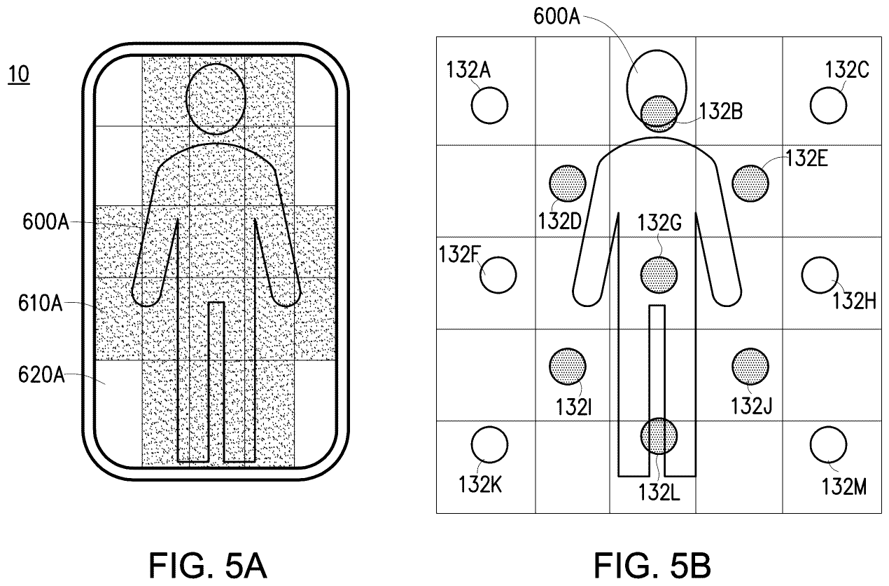

FIG. 5A is a schematic diagram of a first image according to an embodiment of the disclosure. FIG. 5B is a schematic diagram of a first image and an LED array according to an embodiment of the disclosure.

Please first refer to FIG. 5A. FIG. 5A is a screen 10 of a portable electronic device, such as a screen of a mobile phone or a tablet computer.

Before formal capture, the main controller 300 turns on the image capture device 200 to turn on a capture function.

Next, the main controller 300 controls the image capture device 200 to capture a first image 600A. The step is only for pre-capturing an image, solely for the main controller 300 to use for subsequent analysis.

In some embodiments, the distribution of the LED array 132 in the light source module 100 does not completely correspond to the distribution of the first image 600A. Therefore, in order to optimize the illumination effect, after “the main controller 300 controls the image capture device 200 to capture the first image 600A” in the above step, according to a distribution state of the first image 600A, the main controller 300 calculates an optimal rotation position of the rotation motor 110, and the main controller 300 then sends the rotation motor control signal, so that the rotation motor 110 located below the light source module 100 rotates, such that the light source module 100 rotates by the rotation angle to an optimal capture position.

Next, the main controller 300 determines an LED irradiation region 610A according to a distribution position of the first image 600A on the screen. The other regions on the screen are non-irradiation regions 620A.

Next, please reference FIG. 5B. The main controller 300 determines the first LEDs that need to be turned on in the LED array 132 according to the LED irradiation region 610A in FIG. 5A, such as determining that the LED 132B, the LED 132D, the LED 132E, the LED 132G, the LED 132I, the LED 132J, and the LED 132L in the LED array 132 need to be turned on.

Next, the main controller 300 sends the light source control signal to the light source controller 400, so that the light source controller 400 sends the control current, turns on the first LEDs, and captures a second image. For example, in FIG. 5B, the main controller 300 sends the light source control signal to the light source controller 400, so that the light source controller 400 sends the control current, turns on the LED 132B, the LED 132D, the LED 132E, the LED 132G, the LED 132I, the LED 132J, and the LED 132L to provide sufficient illumination, and capture the second image.

Next, the main controller 300 analyzes the second image and confirms whether the second image complies with a required standard. If the second image complies with the required standard, the second image is stored.

On the other hand, if the second image does not comply with the required standard, the main controller 300 sends the light source control signal to the light source controller 400 again, so that the light source controller 400 sends the control current, turns on the LED 132B, the LED 132D, the LED 132E, the LED 132G, the LED 132I, the LED 132J, and the LED 132L, and captures a third image.

Therefore, through the above method, the main controller 300 may determine the LEDs that need to be turned on according to the first image 600A, without having to turn on all the LEDs, thus achieving more precise illumination and reducing the power consumption of the portable electronic device.

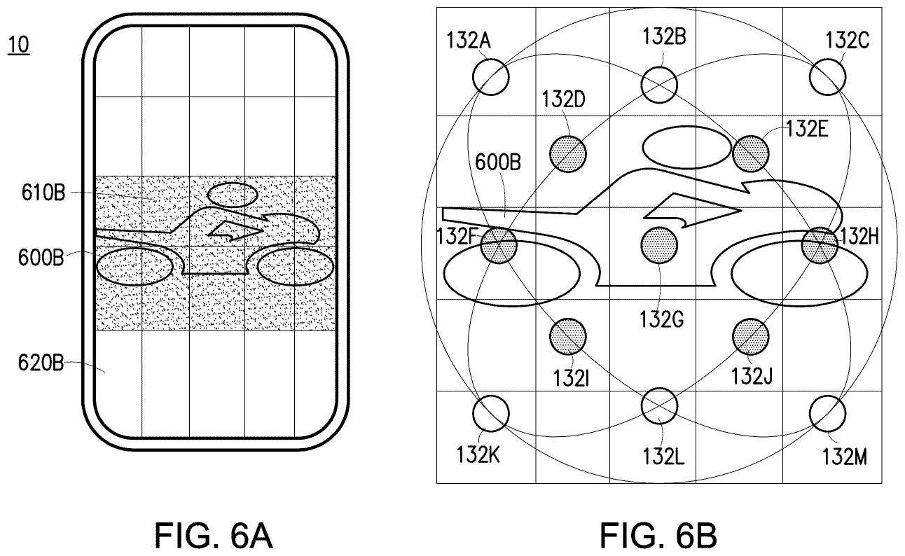

FIG. 6A is a schematic diagram of a first image according to an embodiment of the disclosure. FIG. 6B is a schematic diagram of a first image and an LED array according to an embodiment of the disclosure.

FIG. 6A is similar to FIG. 5A. The difference is that in FIG. 6A, the shape of a first image 600B approximately occupies a middle region of the screen, thus correspondingly changing the shapes and the ranges of an LED irradiation region 610B and a non-irradiation region 620B.

FIG. 6B is similar to FIG. 5B. The difference is that in FIG. 6B, due to changes in the first image 600B and the LED irradiation region 610B, the number and the positions of the LEDs that need to be correspondingly turned on are also different. In FIG. 6B, the LEDs that need to be correspondingly turned on are the LED 132D, the LED 132E, the LED 132F, the LED 132G, the LED 132H, the LED 132I, and the LED 132J.

Therefore, the main controller 300 may determine the LEDs that need to be turned on according to the first image 600B, without having to turn on all the LEDs, thus achieving more precise illumination and reducing the power consumption of the portable electronic device.

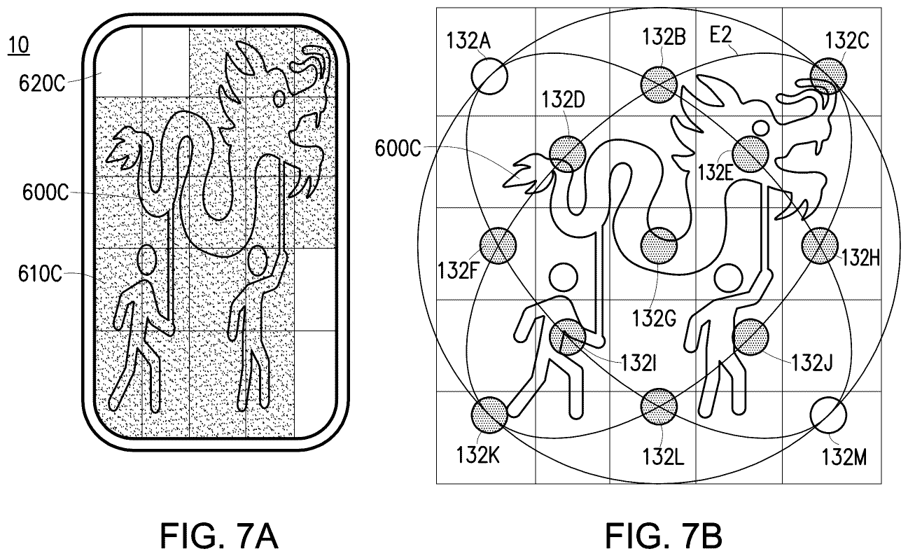

FIG. 7A is a schematic diagram of a first image according to an embodiment of the disclosure. FIG. 7B is a schematic diagram of a first image and an LED array according to an embodiment of the disclosure.

FIG. 7A is similar to FIG. 5A. The difference is that in FIG. 7A, the shape of a first image 600C approximately occupies all regions of the screen except the upper left corner and the lower right corner, thus correspondingly changing the shapes and the ranges of an LED irradiation region 610C and a non-irradiation region 620C.

FIG. 7B is similar to FIG. 5B. The difference is that in FIG. 7B, due to changes in the first image 600C and the LED irradiation region 610C, the number and the positions of the LEDs that need to be correspondingly turned on are also different. In FIG. 7B, the LEDs that need to be correspondingly turned on are the LED 132B, the LED 132C, the LED 132D, the LED 132E, the LED 132F, the LED 132G, the LED 132H, the LED 132I, the LED 132J, the LED 132K, and the LED 132L.

Therefore, the main controller 300 may determine the LEDs that need to be turned on according to the first image 600C, without having to turn on all the LEDs, thus achieving more precise illumination and reducing the power consumption of the portable electronic device.

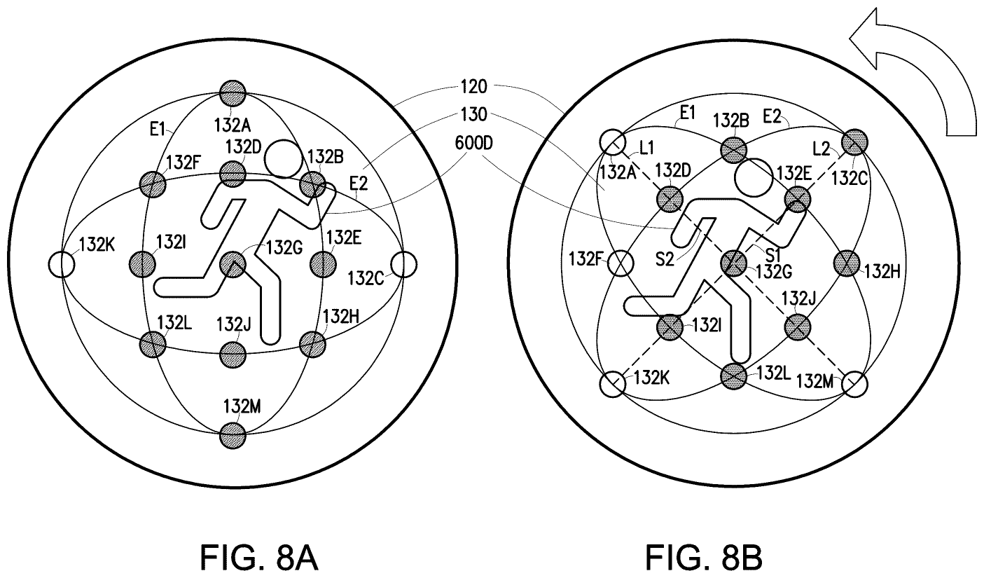

FIG. 8A is a schematic diagram of a first image and an LED array according to an embodiment of the disclosure. FIG. 8B is a schematic diagram of a first image and an LED array according to an embodiment of the disclosure.

Please first refer to FIG. 8A. In FIG. 8A, a first image 600D is approximately located in the middle of an LED array. However, the LED array is not arranged at the most appropriate position relative to the first image 600D. At this time, except for the LED 132C and the LED 132K, a total of 11 LEDs are illuminated. Therefore, according to the first image 600D, after the main controller 300 calculates the optimal rotation position of the rotation motor 110, the main controller 300 sends the rotation motor control signal, so that the rotation motor 110 rotates, and the substrate 130 and the LED array 132 are driven to rotate by the rotation angle to the optimal capture position through the rotation platform 120. For example, in FIG. 8B, the main controller enables the rotation motor 110 to rotate by 45 degrees in the counterclockwise direction, so that the rotation platform 120 and the substrate 130 in the light source module 100 drive the LED array 132 to rotate to reach the optimal capture position. At this time, except for the LED 132A, the LED 132F, the LED 132K, and LED 132M, a total of 9 LEDs are illuminated.

Therefore, the main controller 300 may determine the angle that the light source module needs to rotate according to the position of the first image 600D to reach the optimal capture position. In addition, at the optimal capture position (as shown in FIG. 8B), the number of the LEDs that need to be illuminated may be further reduced to achieve more precise illumination and reduce the power consumption of the portable electronic device.

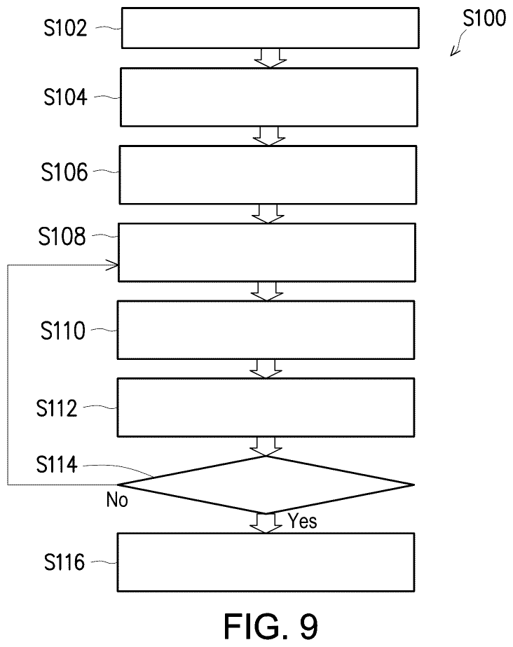

FIG. 9 is a flowchart of a flash illumination method according to an embodiment of the disclosure.

Please refer to FIG. 9. An illumination method S100 includes the following steps.

In step S102, the main controller 300 turns on the image capture device 200 to turn on the capture function. Step S104 is entered.

In step S104, the main controller 300 controls the image capture device 200 to capture the first image, such as the first image 600A of FIG. 5A, the first image 600B of FIG. 6A, the first image 600C of FIG. 7A, or the first image 600D of FIG. 8A. Step S106 is entered.

In step S106, according to the first image, after the main controller 300 calculates the optimal rotation position of the rotation motor 110, the main controller 300 sends the rotation motor control signal, so that the rotation motor 110 located below the light source module 100 rotates, such that the light source module 100 rotates by the rotation angle to the optimal capture position. For example, in FIG. 8B, the light source module 100 is rotated by 45 degrees in the counterclockwise direction. Step S108 is entered.

In step S108, the main controller 300 determines the LED irradiation region according to the clarity of the first image and the position occupied on the screen. Specifically, the main controller 300 determines the LED irradiation region according to the distribution position of the first image. For example, in FIG. 5A, the main controller 300 determines the LED irradiation region 610A according to the distribution position of the first image 600A. For another example, in FIG. 6A, the main controller 300 determines the LED irradiation region 610B according to the distribution position of the first image 600B. For yet another example, in FIG. 7A, the main controller 300 determines the LED irradiation region 610C according to the distribution position of the first image 600C. Step S110 is entered.

In step S110, the main controller 300 determines the first LEDs that need to be turned on in the LED array 132 according to the LED irradiation region. For example, in FIG. 5B, the main controller 300 determines that the LED 132B, the LED 132D, the LED 132E, the LED 132G, the LED 132I, the LED 132J, and the LED 132L in the LED array 132 need to be turned on according to the LED irradiation region 610A. Alternatively, for example, in FIG. 6B, the main controller 300 determines that the LED 132D, the LED 132E, the LED 132F, the LED 132G, the LED 132H, the LED 132I, and the LED 132J in the LED array 132 need to be turned on according to the LED irradiation region 610B. Alternatively, for example, in FIG. 7B, the main controller 300 determines that the LED 132B, the LED 132C, the LED 132D, the LED 132E, the LED 132F, the LED 132G, the LED 132H, the LED 132I, the LED 132J, the LED 132K, and the LED 132L in the LED array 132 need to be turned on according to the LED irradiation region 610C. Step S112 is entered.

In step S112, the main controller 300 sends the light source control signal to the light source controller 400, so that the light source controller 400 sends the control current, turns on the first LEDs, and captures the second image. For example, in FIG. 5B, the main controller 300 sends the light source control signal to the light source controller 400, so that the light source controller 400 sends the control current, and turns on the LED 132B, the LED 132D, the LED 132E, the LED 132G, the LED 132I, the LED 132J, and the LED 132L. Alternatively, for example, in FIG. 6B, the main controller 300 sends the light source control signal to the light source controller 400, so that the light source controller 400 sends the control current, and turns on the LED 132D, the LED 132E, the LED 132F, the LED 132G, the LED 132H, the LED 132I, and the LED 132J. Alternatively, for example, in FIG. 7B, the main controller 300 sends the light source control signal to the light source controller 400, so that the light source controller 400 sends the control current, and turns on the LED 132B, the LED 132C, the LED 132D, the LED 132E, the LED 132F, the LED 132G, the LED 132H, the LED 132I, the LED 132J, the LED 132K, and the LED 132L. Step S114 is entered.

In step S114, the main controller 300 analyzes the second image and confirms whether the second image complies with the required standard. If the second image complies with the required standard, step S116 is entered. If the second image does not comply with the required standard, the method returns to step S108.

In step S116, if the second image complies with the required standard, the second image is stored.

If in step S114, the second image does not comply with the required standard, the method returns to step S108, wherein the main controller 300 sends the light source control signal to the light source controller 400 again, so that the light source controller 400 sends the control current, turns on the first LEDs, and captures the third image.

Based on the above, in the flash and the flash illumination method provided by the disclosure, the capture effect of the LED flash is optimized through the elliptically arranged LED flash in conjunction with the micro motor and algorithm operation, which may cover a large range of the capture region, and only the required LEDs are illuminated. Therefore, the system power consumption may be reduced, and light may be filled for specific detail positions during capture to be suitable for flash capture under various ambient brightness.

What is claimed is:

1. A flash, comprising:
a light source module, comprising a light emitting diode (LED) array and used to emit light;
an image capture device;
a light source controller, electrically connected to the light source module and used to control a light emitting state of the light source module;
a main controller, electrically connected to the image capture device and the light source controller,
wherein the main controller is configured to:
enable the image capture device to capture a first image;
analyze the first image to determine an LED irradiation region;
determine a plurality of first LEDs that need to be turned on in the LED array according to the LED irradiation region;
send a light source control signal to the light source controller, so that the light source controller sends a control current, and turns on the first LEDs.

2. The flash according to claim 1, wherein the LED array comprises a plurality of LEDs, the LEDs are distributed within a range formed by a first ellipse and a second ellipse, wherein a long axis of the first ellipse passes through a midpoint of a long axis of the second ellipse and is perpendicular to the long axis of the second ellipse, and a size of the first ellipse is the same as a size of the second ellipse.

3. The flash according to claim 2, wherein the LEDs within the first ellipse are arranged in a first distribution, the LEDs within the second ellipse are arranged in a second distribution, and the first distribution and the second distribution have a same shape.

4. The flash according to claim 2, wherein the LEDs within the first ellipse are mirror-symmetrical along the long axis of the first ellipse or mirror-symmetrical along a short axis of the first ellipse.

5. The flash according to claim 2, wherein the LEDs within the second ellipse are mirror-symmetrical along the long axis of the second ellipse or mirror-symmetrical along a short axis of the second ellipse.

6. The flash according to claim 1, wherein in the step of analyzing the first image to determine the LED irradiation region, the main controller determines the LED irradiation region according to a distribution position of the first image.

7. The flash according to claim 1, wherein the light source module further comprises:
a substrate, wherein the LED array is disposed on the substrate;
a housing, disposed on the substrate and surrounding the LED array;
a lens, disposed on the housing and covering the LED array.

8. The flash according to claim 7, further comprising:
a rotation platform, disposed at a bottom portion of the substrate;
a rotation motor, disposed at a bottom portion of the rotation platform;
a rotation motor controller, electrically connected to the rotation motor and the main controller,
wherein before analyzing the first image to determine the LED irradiation region, the main controller is configured to:
analyze the first image to determine a rotation angle of the light source module;
send a rotation motor control signal, so that the rotation motor rotates and drives the rotation platform, such that the light source module rotates by the rotation angle.

9. A flash illumination method, comprising:
controlling an image capture device to capture a first image by a main controller;
analyzing the first image to determine an LED irradiation region in an LED array of a light source module by the main controller;
determining a plurality of first LEDs that need to be turned on in the LED array according to the LED irradiation region by the main controller;
sending a light source control signal to the light source controller by the main controller, so that the light source controller sends a control current, turns on the first LEDs, and captures a second image;
analyzing the second image and confirming whether the second image complies with a required standard by the main controller;
when the second image complies with the required standard, storing the second image;
when the second image does not comply with the required standard, sending the light source control signal to the light source controller again by the main controller, so that the light source controller sends the control current, turns on the first LEDs, and captures a third image.

10. The flash illumination method according to claim 9, wherein in the step of analyzing the first image to determine the LED irradiation region by the main controller, the main controller determines the LED irradiation region according to a distribution position of the first image.

11. The flash illumination method according to claim 9, wherein before analyzing the first image to determine the LED irradiation region by the main controller, the flash illumination method further comprises:
analyzing the first image to determine a rotation angle of the light source module;
sending a rotation motor control signal by the main controller, so that a rotation motor located below the light source module rotates, such that the light source module rotates by the rotation angle.
